(19) United States
(12) Patent Application Publication
(10) Pub. No.: US 2008/0282246 A1
(43) Pub. Date: Nov. 13, 2008

(54) COMPILER AIDED TICKET SCHEDULING OF TASKS IN A COMPUTING SYSTEM

(76) Inventors: Danny Dolev, Mevaseret Zion (IL); Tal Anker, EliShema (IL); Yaron Weinsberg, Pisgat Zeev (IL)

Correspondence Address: FOLEY & LARDNER LLP, 150 EAST GILMAN STREET, P.O. BOX 1497, MADISON, WI, 53701-1497, US

(21) Appl. No.: 11/745,042

(22) Filed: May 7, 2007

(51) Int. Cl. G06F 9/46

(52) U.S. Cl. 718/102

(57) ABSTRACT

A method of scheduling tasks for execution in a computer system includes determining a dynamic worst case execution time for a non-periodic task. The dynamic worst case execution time is based on an actual execution path of the non-periodic task. An available time period is also determined, wherein the available time period is an amount of time available for execution of the non-periodic task. The non-periodic task is scheduled for execution if the dynamic worst case execution time is less than the available time period.

### FIELD

The subject of the disclosure relates generally to task scheduling in a computing system. More specifically, the disclosure relates to a method, device, and computer program product for using compiler generated tickets to schedule tasks such that central processing unit usage is optimized.

### BACKGROUND

A computing system can utilize a task scheduling algorithm to determine an order in which operations (or tasks) to be performed by the computing system are executed. Tasks in a task set can be broken down into two categories, periodic and non-periodic. A periodic task can be one which the computing system is supposed to implement at least one time during a given period. The period can be any time duration, and each periodic task can have a distinct period. For example, a periodic task can have a period of fifty milliseconds (ms) such that the operating system is required to implement the periodic task at least one time every fifty ms after the periodic task is initially released for execution. A non-periodic task can be one which the computing system executes during an available time period in which no periodic tasks are being implemented. Non-periodic tasks are generally lower in priority than periodic tasks.

In many instances, a given task in the task set can include a plurality of execution paths upon which the task may execute. The execution path which is actually used by the given task depends in part on the execution path of the task which immediately precedes the given task. The execution path which is actually used can also depend on the central processing unit's (CPU) current work load and other factors. The time needed to complete execution of the task can vary depending on the task's actual execution path. A dynamic worst case execution time (WCET) can refer to the worst case estimate of the execution time of a given task along the task's actual execution path. A global WCET can refer to the largest dynamic WCET for a given task. For example, a task A may have a dynamic WCET of seven ms along a first execution path, a dynamic WCET of nine ms along a second execution path, and a dynamic WCET of twelve ms along a third execution path. The global WCET for task A can be twelve ms. Thus, given normal operating conditions, task A should never take more than twelve ms to execute.

Traditional scheduling algorithms use the global worst case execution times (WCETs) of each task in the task set to generate a pre-determined task schedule. The pre-determined task schedule is generally a fixed schedule which sets forth the order in which each periodic task is to be implemented. For example, the pre-determined task schedule can instruct the scheduling algorithm to execute periodic task A within a first time interval, periodic task B within a second time interval, and periodic task C within a third time interval. Based on the global WCETs of non-periodic tasks, the scheduling algorithm can cause the non-periodic tasks to execute in between the periodic tasks. For example, periodic task A can be released at zero ms and complete execution by a time of ten ms, and periodic task B may not be released for possible execution until twenty ms. The scheduling algorithm can identify a non-periodic task D which has a global WCET which is less than or equal to ten ms and schedule non-periodic task D such that its execution is complete prior to the release of periodic task B.

Unfortunately, the use of global WCETs results in sub-optimal usage of the central processing unit (CPU) of the computer upon which the tasks are being implemented. In real time task execution, a task is often able to execute in a time which is significantly less time its global WCET. As a result, there is often excessive idle time during which no task is being implemented. For example, a task set may include two non-periodic tasks, a non-periodic task W with a global WCET of ten ms and a dynamic WCET of six ms, and a non-periodic task X with a global WCET of sixteen ms and a dynamic WCET of ten ms. If the available time period for execution of a non-periodic task is eleven ms, a traditional task scheduling algorithm will schedule task non-periodic task W for execution because the global WCET of non-periodic task W is less than eleven ms. Because the dynamic WCET of non-periodic task W was only six ms, there are at least five ms of available time until a periodic task is executed. This five ms is an idle time because neither non-periodic task W nor non-periodic task X has a global WCET of five ms or less. If the task scheduling algorithm is able to use the dynamic WCET (ten ms) of non-periodic task X, non-periodic task X could have been scheduled and completed execution within the available time period of eleven ms, resulting in at most one ms of idle time. Excessive idle time corresponds to decreased performance of the computing the system and execution of fewer non-periodic tasks.

Among other things, current task scheduling algorithms are also limited in their ability to effectively divide non-periodic tasks into rapidly executing segments, their ability to utilize actual execution times as opposed to worst case scenarios, and their ability to efficiently determine available time periods for execution of non-periodic tasks. Thus, there is a need for a task scheduling algorithm which is able to use dynamic worst case execution times to create an optimal task schedule. Further, there is a need for a task scheduling algorithm capable of scheduling subsequent tasks based on the actual execution time of a previously scheduled task. Further, there is a need for a task scheduling algorithm capable of effectively dividing tasks into segments such that more non-periodic tasks can be executed. Further yet, there is a need for a task scheduling algorithm capable of receiving up-to-date runtime information in the form of a ticket corresponding to a task.

### SUMMARY

An exemplary method of scheduling tasks for execution in a computer system includes determining a dynamic worst case execution time for a non-periodic task. The dynamic worst case execution time is based on an actual execution path of the non-periodic task. An available time period is also determined, wherein the available time period is an amount of time available for execution of the non-periodic task. The non-periodic task is scheduled for execution if the dynamic worst case execution time is less than the available time period.

An exemplary computer-readable medium has computer-readable instructions stored thereon that, upon execution by a processor, cause the processor to schedule tasks for execution. The instructions are configured to generate a first ticket for a non-periodic task, wherein the first ticket comprises a dynamic worst case execution time for the non-periodic task. The instructions are also configured to generate a second ticket for a periodic task, wherein the second ticket comprises a parameter corresponding to the periodic task. The instructions are further configured to determine an available time period based at least in part on the parameter. The non-periodic task is scheduled for execution if the dynamic worst case execution time is less than or equal to the available time period.

An exemplary method of implementing a computing system includes defining a task set, wherein the task set includes a periodic task and a non-periodic task. One or more worst case execution times for the periodic task and one or more worst case execution times for the non-periodic task are determined. A periodic task schedule is generated based at least in part on the one or more worst case execution times for the periodic task. At least one of the one or more worst case execution times for the non-periodic task is provided to a task scheduling algorithm such that the task scheduling algorithm can determine whether the non-periodic task can be scheduled for execution during an available time period such that the periodic task schedule is not disrupted.

An exemplary computing device includes a task scheduling application, a memory, and a processor. The task scheduling application includes computer code configured to receive a dynamic worst case execution time of a non-periodic task, wherein the dynamic worst case execution time is based on an actual execution path of the non-periodic task. The computer code is also configured to determine an available time period, wherein the available time period is an amount of time available for execution of the non-periodic task. The computer code is further configured to schedule the non-periodic task for execution if the dynamic worst case execution time is less than the available time period. The memory is configured to store the task scheduling application. The processor is coupled to the memory and configured to execute the task scheduling application.

Other principal features and advantages will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings.

FIG. 1 is a flow diagram illustrating operations performed during a ticket creation process in accordance with an exemplary embodiment.

FIG. 2 is a graphical representation of parameters associated with a periodic task in accordance with an exemplary embodiment.

FIG. 3 is a flow diagram illustrating operations performed by a task scheduling algorithm in accordance with an exemplary embodiment.

FIG. 4A is a task definition table illustrating parameters of a task set of a space shuttle system in accordance with an exemplary embodiment.

FIG. 4B is a table summarizing parameter information included in the task definition table described with reference to FIG. 4A in accordance with an exemplary embodiment.

FIG. 5 is a table illustrating worst case execution times of task segments in the space shuttle system in accordance with an exemplary embodiment.

FIG. 6A is a graph illustrating space shuttle system tasks scheduled by a regular earliest deadline first task scheduling algorithm in accordance with an exemplary embodiment.

FIG. 6B is a graph illustrating space shuttle tasks scheduled by a compiler-aided ticket scheduling enhanced earliest deadline first task scheduling algorithm.

FIG. 7A is a graph illustrating a comparison of invocation times of a search for extraterrestrial intelligence task in accordance with an exemplary embodiment.

FIG. 7B is a graph illustrating a comparison of invocation times of a star map task in accordance with an exemplary embodiment.

FIG. 7C is a graph illustrating a comparison of the time in between consecutive invocations of the search for extraterrestrial intelligence task in accordance with an exemplary embodiment.

FIG. 7D is a graph illustrating a comparison of the time in between consecutive invocations of the star map task in accordance with an exemplary embodiment.

### DETAILED DESCRIPTION

Disclosed herein is a method of enhancing a task scheduling algorithm such that central processing unit (CPU) usage in a computing system can be optimized. In an exemplary embodiment, a compiler can be used to generate one or more tickets for each task within a task set to be executed by the CPU. Among other information, the one or more tickets can include a dynamic worst case execution time (WCET) of each task and/or task segment which is ready for execution. The dynamic WCET can be based on runtime information including an execution path of a currently executing task or task segment. The compiler-generated tickets can be used by the task scheduling algorithm to schedule a subsequent task or task segment which results in minimal idle time for the CPU.

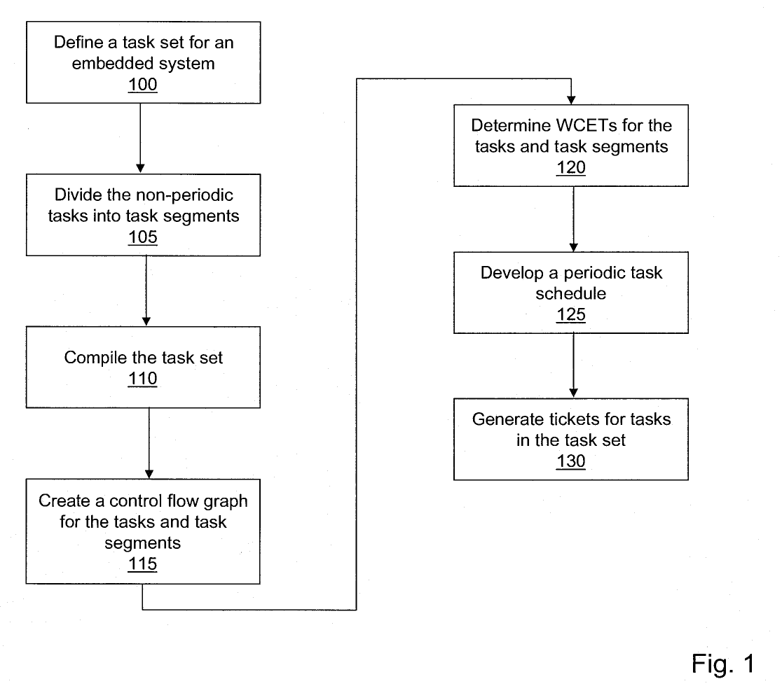

FIG. 1 is a flow diagram illustrating operations performed during a ticket creation process in accordance with an exemplary embodiment. Additional, fewer, or different operations may be performed in alternative embodiments. In an operation 100, a task set for an embedded system is defined. Defining the task set can include identifying tasks to be executed within the embedded system and/or creating source code corresponding to the tasks. In an exemplary embodiment, the task set can be manually defined by one or more programmers. Alternatively, the task set can be defined automatically by a computer or by any other method known to those of skill in the art.

The task set can include any number of tasks which, when executed, perform an operation within the embedded system. The task can be a maintenance operation, a receive signal operation, a send signal operation, a status check operation, a data collection operation, a security operation, or any other operation which can be implemented in a computing system as known to those of skill in the art. In an exemplary embodiment, the task set can be a hybrid task set which includes a periodic task set including one or more periodic tasks and a non-periodic task set including one or more non-periodic tasks. A periodic task can refer to any operation or set of operations which is supposed to execute at least one time during each period of the periodic task. The period can be any time interval, and can vary among periodic tasks. A non-periodic task can refer to any operation or set of operations which does not include a period during which the operations are supposed to execute. Non-periodic tasks can be executed before, after, and/or in between periodic tasks. In alternative embodiments, the task set can include any other types or combinations of tasks known to those of skill in the art.

In an operation 105, the non-periodic tasks are divided into task segments. In an exemplary embodiment, only non-periodic tasks may be divided into task segments. Alternatively, both non-periodic and periodic tasks may be divided into task segments. A task segment can be any portion of a non-periodic (or periodic) task which is capable of being executed independent of any other portion of the non-periodic task. In an exemplary embodiment, a task segment of a non-periodic task is able to execute more rapidly than the entire non-periodic task. As such, task segments can be scheduled to execute during available time periods of short duration in which the entire non-periodic task could not complete execution. An available time period can refer to any period of time before, after, or in between execution of periodic tasks in which a non-periodic task can execute without interfering with a periodic task schedule. As an example of task division, a non-periodic task A with a global WCET of eight ms can be divided into a first task segment with a global WCET of three ms and a second task segment with a global WCET of five ms. If there is an available time period of four ms, non-periodic task A may not be able to execute in its entirety because its global WCET is eight ms. However, based on its global WCET of three ms, the first segment task should easily be able to complete execution within the available time period of four ms. Alternatively, depending on its actual execution path (which may result in a dynamic WCET of less than or equal to four ms), the second task segment may be able to complete execution within the available time period. Thus, dividing tasks into segments can increase CPU usage and the amount of non-periodic tasks which are executed during runtime.

In one embodiment, the non-periodic tasks can be divided manually by a source code programmer. The source code programmer can manually implement the division by inserting an execution command into the source code such that control of the CPU is relinquished upon completion of a non-periodic task segment. The execution command can be a yield command or any other execution command known to those of skill in the art. In an alternative embodiment, the source code programmer can manually divide the non-periodic tasks by creating each task segment as a separate piece of source code. Alternatively, the source code programmer can divide the tasks using any other method known to those of skill in the art.

In one embodiment, the non-periodic tasks are not divided into segments until runtime. In such an embodiment, a task scheduling algorithm, compiler, or other algorithm can be used to automatically divide the non-periodic tasks into segments based on a current available time period. The task scheduling algorithm (or other algorithm) can identify logical breaks in the source code of a non-periodic task, and use the logical breaks to identify task segments into which the non-periodic task can potentially be divided. The task scheduling algorithm can also identify dynamic WCETs corresponding to the potential task segments. Based on a comparison of the dynamic WCETs of potential task segments and the available time period, the task scheduling (or other) algorithm can divide the non-period task into a first task segment which utilizes a maximal amount of the available time period, and a second task segment to be executed during a subsequent available time period. As a result, CPU usage can be further optimized. In an exemplary embodiment, the logical breaks can be explicitly included within the source code of the non-periodic task by a programmer. Alternatively, the logical breaks can be implicitly recognized by the compiler based on source code patterns or other criteria.

As an example of a logical break, a non-periodic task can be a ‘capture and send photo’ operation used to capture a photograph with a camera in communication with the computing system and send the photograph to a destination. A logical break can be between the capture and send operations such that the non-periodic task can be divided into two logical task segments, a ‘capture photo’ task segment and a ‘send photo’ task segment. The logical break can be represented by an execution command in the source code of the non-periodic task, an identifier manually placed in the source code of the non-periodic task, or any other identifier known to those of skill in the art. Alternatively, the logical break may not be explicitly represented, but rather can be identified based on a source code pattern or other criteria. In an alternative embodiment, the non-periodic task can include any other number of logical breaks, and/or can be divided into any other number of logical task segments.

In an exemplary embodiment, task segments can be executed in a sequential order until all of the task segments for a given non-periodic task have executed. For example, a non-periodic task can have four task segments. A first task segment of the non-periodic task can execute during a first available time period, a second task segment can execute during a second available time period subsequent to the first available time period, and a third task segment and a fourth task segment can execute during a third available time period subsequent to the second available time period. Upon sequential execution of all four task segments, the first task segment can execute during a fourth available time period subsequent to the third available time period, and so on such that the task segments of the non-periodic task always execute in the same order. In an alternative embodiment, one or more task segments in a non-periodic task may be order independent such that they can execute regardless of whether any other task segments have completed execution.

In an operation 110, the task set is compiled. In an exemplary embodiment, the task set can be compiled by a compiler. The compiler can be a translator which accepts source code corresponding to the tasks as an input and creates a machine-readable program as an output. The compiler can also refer to any other algorithm capable of converting the source code of each task into a format which can be executed by the CPU of a computing system.

In an operation 115, a control flow graph is created for the tasks and task segments. In an exemplary embodiment, the control flow graph can be a graphical representation of possible execution paths of the tasks. In one embodiment, a single control flow graph can be used to represent all of the tasks and task segments. Alternatively, a separate control flow graph can be created for each task and/or task segment. The control flow graph can include nodes representing each instruction block of a task. An instruction block of a task can be any basic command, basic operation, or other basic instruction which is implemented as the task is executed. In an exemplary embodiment, the series of instruction blocks which form a task are executed in the same sequence each time the task executes. Thus, the nodes corresponding to the instruction blocks of a given task can appear in the same order along each possible execution path in the control flow graph. The control flow graph can also include edges which connect the nodes and indicate a sequential progression along the execution path. If a given instruction block within a task consecutively executes for a plurality of times, the edge extending from the node corresponding to the instruction block can be weighted to indicate the number of executions. In an exemplary embodiment, the control flow graph can be created using any control flow graph creation algorithm known to those of skill in the art. The control flow graph creation algorithm may be incorporated within the compiler, incorporated within the task scheduling algorithm, or implemented as a standalone algorithm, depending on the embodiment.

In an operation 120, worst case execution times (WCETs) are determined for the tasks and task segments. In an exemplary embodiment, the WCETs can be determined using a WCET estimator. The WCET estimator can be a simulator, an estimation algorithm, or any other worst case estimation algorithm known to those of skill in the art. In an exemplary embodiment, the WCET estimator can be incorporated into the compiler. Alternatively, the WCET estimator can be incorporated into the task scheduling algorithm, incorporated into any other algorithm within the computing system, and/or implemented as a standalone algorithm. In an exemplary embodiment, each task and/or task segment can have a plurality of dynamic WCETs (one for each execution path). The largest of the dynamic WCETs can be referred to as the global WCET of the task or task segment.

In an exemplary embodiment, the WCET estimator can be any algorithm capable of estimating the time it takes an instruction block to execute under a given set of conditions. The instruction blocks of each task along each potential execution path can be identified using the control flow graph. In an exemplary embodiment, the set of conditions used by the WCET estimator can be the set of conditions which result in the longest execution time of the instruction block. Alternatively, the set of conditions used by the WCET estimator can be those which result in a minimum or average execution time of the instruction block. In one embodiment, the WCET estimator can use a simulator to simulate the desired set of conditions such that execution time can be determined. Alternatively, the WCET estimator can manually impose the actual worst case conditions on the computing system and time how long it takes for each instruction block to actually complete execution.

In an exemplary embodiment, the WCET estimator can use the control flow graph to identify each of the potential execution paths for each task and/or task segment. As an example, a control flow graph of a task segment can include two execution paths, each of which includes two instruction blocks. Along the first execution path of the task segment, the WCET estimator can determine that the worst case execution time of a first instruction block is six ms. The WCET estimator can also determine that the WCET of a second instruction block is four ms. As such, the first execution path can have a dynamic WCET of ten ms along the first execution path. Along the second execution path of the task segment, the WCET estimator can determine that the WCET of the first instruction block is three ms and the WCET of the second instruction block is five ms, resulting in a dynamic WCET of eight ms. Thus, the global WCET for the task segment is ten ms. This process can be repeated until a dynamic WCET time is determined for each task and/or task segment along each possible execution path. In one embodiment, the WCET estimator may determine only the global WCET for each of the periodic tasks. In an alternative embodiment, the WCET estimator can identify the execution paths using any other method known to those of skill in the art.

In an operation 125, a periodic task schedule is developed. The periodic task schedule can be used as a guideline by the task scheduling algorithm to determine when a particular periodic task should be scheduled. In an exemplary embodiment, the periodic task schedule can be based on WCETs associated with the periodic tasks and/or any other parameters assigned to the periodic tasks. Parameters can be assigned to a periodic task when the periodic task is first defined, after any WCETs associated with the periodic task have been determined, or at any other time. In an exemplary embodiment, the parameters can be manually assigned by programmers. Alternatively, the parameters can be automatically assigned by the task scheduling algorithm, the compiler, or any other algorithm. In an exemplary embodiment, the parameters associated with each periodic task can include a release time, a release interval, a deadline, and a periodic task priority. In alternative embodiments, any other parameters can be assigned to the periodic tasks.

The release time of a periodic task can be the first time after startup at which the periodic task is released for execution such that the periodic task can be scheduled for execution. For example, a periodic task A can have a release time of ten ms such that periodic task A cannot commence execution until at least ten ms after startup. In an alternative embodiment, a release time may not be assigned to periodic tasks such that a synchronous periodic task set is created. In a synchronous periodic task set, each periodic task can have the same release time. In an exemplary embodiment, the release time of each periodic task in the synchronous periodic task set can be the time at startup (zero ms). In alternative embodiments, the release time in a synchronous periodic task set can be any other value.

Each periodic task can also be assigned a release interval. The release interval can be a time interval between consecutive releases of the periodic task. For example, periodic task A can have a release time of ten ms and a release interval of twenty ms. As such, periodic task A is initially released at ten ms and is re-released at thirty ms, fifty ms, seventy ms, etc. The periodic task can also include a deadline. The deadline can be a time interval during which the periodic task should complete execution after a release. Alternatively, the deadline can refer to the actual time during runtime by which the periodic task should complete execution. Using the example above, if periodic task A has a deadline of fifteen ms, a first execution of periodic task A should be complete by twenty-five ms, a second execution of periodic task A should be complete by forty-five ms, a third execution of periodic task A should be complete by sixty-five ms, etc. In an exemplary embodiment, one or more periodic tasks can have the same deadline value. Alternatively, each periodic task can have a distinct deadline. In an exemplary embodiment, the deadline and release interval of a given periodic task can be the same value such that, upon release, the periodic task should execute prior to a subsequent release. Alternatively, the deadline and release intervals can be distinct values.

The periodic task can also be assigned a periodic task priority. The periodic task priority can be used to rank periodic tasks within the periodic task set by importance. For example, a periodic task C can be a ‘stay awake’ operation which causes the embedded system to shut down if it is not executed before its deadline. Periodic task B can be a ‘check printer’ operation used to periodically check whether a printer connected to the embedded system is functional. Periodic task A can be a ‘camera adjust’ operation used to periodically focus a camera connected to the embedded system. In an exemplary embodiment, periodic task C can be the highest priority task and can have a periodic task priority of three, periodic task A can have a periodic task priority of two, and periodic task B can have a periodic task priority of one. Alternatively, periodic task C can have a periodic task priority of three and periodic tasks A and B can both have a periodic task priority of two. In another alternative embodiment, the tasks can be prioritized in any other order. In an exemplary embodiment, periodic task priorities can be used by the scheduling algorithm to help determine which periodic task to schedule when one or more periodic tasks have been released for execution. In an alternative embodiment, periodic task priorities may not be assigned to any or all of the periodic tasks.

In an exemplary embodiment, a non-periodic task is not assigned a release time, a release interval, or a deadline. Alternatively, a given non-periodic task may include a release time, which can be the first time after startup at which the non-periodic task can potentially be executed. In another exemplary embodiment, non-periodic tasks may be assigned a non-periodic task priority. The non-periodic task priority can be similar to the periodic task priority assigned to periodic tasks. The non-periodic task priority can be used by the scheduling algorithm to help determine which non-periodic task to schedule when one or more non-periodic tasks with similar or identical dynamic WCETs are able to be scheduled for execution during an available time period. In an alternative embodiment, non-periodic task priorities may not be assigned to any or all of the non-periodic tasks. In another exemplary embodiment, each task segment corresponding to a single non-periodic task can have the same non-periodic task priority.

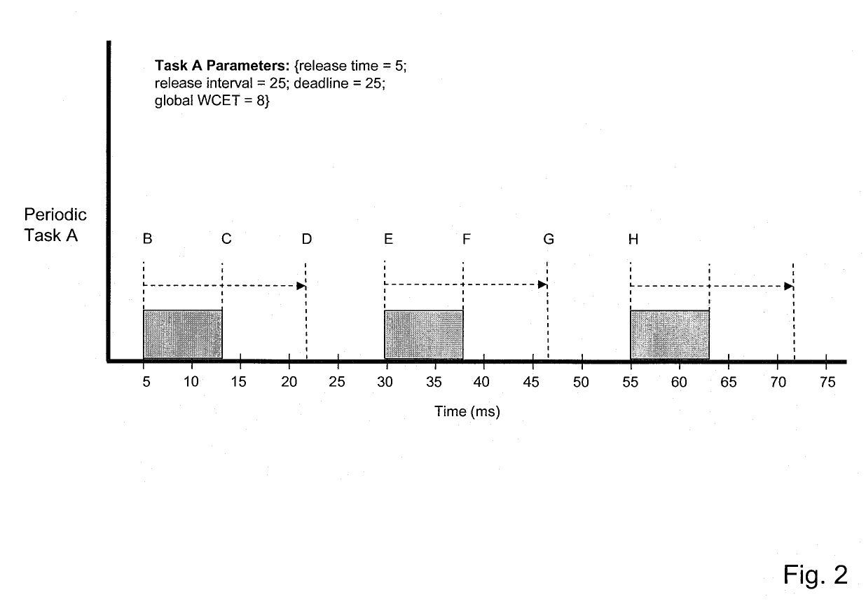

FIG. 2 is a graphical representation of parameters associated with a periodic task A in accordance with an exemplary embodiment. Periodic task A has a release time of five ms, a release interval of twenty-five ms, a deadline of twenty-five ms, and a global WCET of eight ms. In alternative embodiments, the release interval and deadline can be distinct values. In another alternative embodiment, a dynamic WCET corresponding to a particular execution path of periodic task A can be used. In an exemplary embodiment, time B can correspond to the release time of five ms. Time C (thirteen ms) can correspond to the latest time at which periodic task A should complete execution if periodic task A is scheduled to commence execution at its release time. Time D (twenty-two ms) can correspond to the latest time at which periodic task A should begin to execute such that there is no risk of missing the deadline. Time E can be the deadline (thirty ms) corresponding to the initial release of periodic task A. Time E can also correspond to a second release of periodic task A based on the release interval of twenty-five ms. Time F (thirty-eight ms) can correspond to the latest time at which periodic task A should complete its second execution if periodic task A is scheduled to commence execution at its second release time. Similarly, time G (forty-seven ms) can correspond to the latest time at which periodic task A should begin its second execution such that there is no risk of missing the deadline. Time H (fifty-five ms) can be the deadline corresponding to the second release of periodic task A, and can also correspond to a third release of periodic task A.

Referring back to FIG. 1, the parameters assigned to each periodic task can be selected to ensure that the periodic task schedule can be implemented. The processes of assigning parameters and creating the periodic task schedule can be iterative such that an optimal periodic task schedule can be created. In another exemplary embodiment, the periodic task schedule can be designed to allow time slots during which no periodic task is being executed such that non-periodic tasks or task segments can be executed. In another exemplary embodiment, the periodic task schedule can be designed to include a maximum available time period which is greater than or equal to the largest WCET of any non-periodic task. The maximum available time period can be the largest possible time duration available for execution of a non-periodic task without breeching a deadline of a periodic task. If the maximum available time period is smaller than any WCET of a non-periodic task, the non-periodic may not ever have enough time to complete execution. For example, if the maximum available time period is eight ms and the WCET of a non-periodic task is ten ms, the non-periodic task may rarely or never be able to execute.

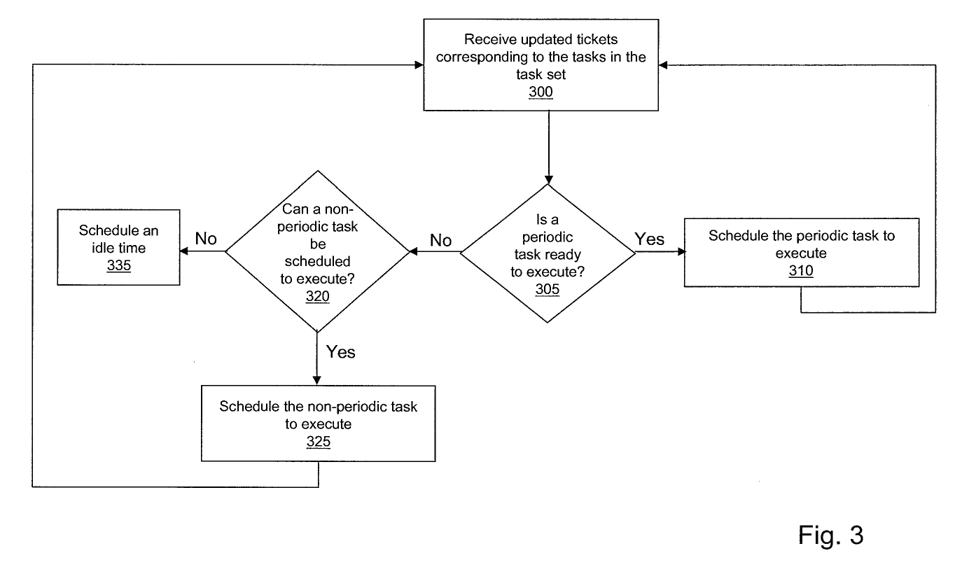

In an operation 130, tickets are generated for tasks in the task set. A ticket can refer to any data structure capable of being used to provide information to the task scheduling algorithm. In an exemplary embodiment, the tickets can be generated by the compiler using the determined WCETs of the tasks and/or any other parameters assigned to the tasks. Alternatively, the tickets can be generated by the task scheduling algorithm, or any other algorithm with access to task WCET and/or task parameter information. Once generated, the tickets can be used by the task scheduling algorithm to make runtime decisions regarding which tasks or task segments should execute such that CPU usage is maximized. Use of the tickets by the scheduling algorithm is described in more detail with reference to FIG. 3.

A ticket for a non-periodic task can include a dynamic WCET based on a current execution path of the non-periodic task. The current execution path can refer to the execution path upon which the non-periodic task would execute if the non-periodic task were scheduled for execution by the task scheduling algorithm. As such, the ticket of the non-periodic task can be continually updated throughout runtime to reflect the proper dynamic WCET. The ticket of the non-periodic task can also include a non-periodic task priority of the non-periodic task, and/or any other information associated with the non-periodic task. In an exemplary embodiment, each non-periodic task may be represented by a single ticket. If the non-periodic task has been divided into segments, the ticket can reflect the dynamic WCET of the next segment which is to be executed. For example, if a first segment has executed, the ticket can reflect the dynamic WCET of a second segment. In an alternative embodiment, each task segment can have a distinct ticket. In another alternative embodiment, a distinct ticket can be used to represent each dynamic WCET of each task. In such an embodiment, a task can have at least one ticket for each possible execution path of the task.

In an exemplary embodiment, a ticket for a periodic task can include the dynamic WCET, the release interval, and/or the periodic task priority of the periodic task. In another exemplary embodiment, the ticket for a periodic task can also include the next time at which the periodic task is to be released and/or the latest time by which the periodic task should begin to execute in order to meet its deadline requirement. Alternatively, the ticket can also include the global WCET of the periodic task, the deadline value of the periodic task, and/or the release time of the periodic task. In an exemplary embodiment, the ticket of a periodic task can be continually updated throughout runtime to correctly reflect the dynamic WCET of the periodic task. In one embodiment, ticket can also be updated to reflect any parameter-based information which changes throughout runtime. Such parameter-based information can include the next release time of the periodic task, the time by which periodic task execution has to commence such that the periodic task meets its deadline, etc. In an exemplary embodiment, each periodic task can be represented by a single ticket which is updated to reflect current values. In alternative embodiments, a single periodic task can be represented by a plurality of tickets.

In an exemplary embodiment, tickets can be updated during runtime with up-to-date information. For example, a periodic task F can be executing at a given time during runtime. While periodic task F is executing, the compiler (or other algorithm) can identify the execution path of periodic task F. The compiler can use the identified execution path of periodic task F to help determine the execution path of each periodic task, non-periodic task, and/or task segment which can potentially be executed subsequent to periodic task F. The compiler can look up the dynamic WCETs corresponding to the determined execution paths and update any or all of the tickets such that they reflect the dynamic WCETs. The task scheduling algorithm can use the dynamic WCETs to optimally schedule the next task or task segment. In an exemplary embodiment, tickets can be updated upon invocation of a yield or other relinquish command. The yield command can be invoked whenever a task or task segment has completed execution such that control of the CPU is relinquished. Alternatively, tickets can be updated based on any other event which indicates that a currently executing task is complete.

FIG. 3 is a flow diagram illustrating operations performed by a task scheduling algorithm in accordance with an exemplary embodiment. Additional, fewer, or different operations may be performed in alternative embodiments. In an operation 300, the task scheduling algorithm receives updated tickets corresponding to the tasks in the task set. In an exemplary embodiment, the updated tickets can be received at any time after startup of the computing system. In another exemplary embodiment, at least a portion of the updated tickets can include dynamic worst case execution times (WCETs) such that the task scheduling algorithm can generate an optimal schedule with minimal idle time. Idle time can refer to any time duration during runtime in which no task is being executed.

In one embodiment, the task scheduling algorithm can be an earliest deadline first (EDF) task scheduling algorithm. An EDF task scheduling algorithm can be one which schedules released periodic tasks based on their deadlines. For example, if a first (released) periodic task has a deadline of fifty ms and a second (released) periodic task has a deadline of fifty-five ms, the EDF task scheduling algorithm can schedule the first period task prior to scheduling the second periodic task. In an exemplary embodiment, a periodic task cannot execute until it has been released. If two released periodic tasks have the same deadline, the EDF task scheduling algorithm can schedule the periodic task with the higher periodic task priority first. In another exemplary embodiment, the task scheduling algorithm can be a non-preemptive task scheduling algorithm such that an executing task is not interrupted until the executing task is completed and relinquishes control of the CPU. Use of a non-preemptive task scheduling algorithm can increase runtime performance by lowering the overhead imposed when the CPU is interrupted by the triggering of an external event. Alternatively, the task scheduling algorithm can be a preemptive task scheduling algorithm, and the tickets can be used to determine whether an executing task should be interrupted. In alternative embodiments, the task scheduling algorithm can be any other type of task scheduling algorithm which can be adapted to utilize the information included in a ticket. In one embodiment, the task scheduling algorithm can be a plug-in to the compiler. Alternatively, the task scheduling algorithm can be a standalone algorithm.

In an exemplary embodiment, the task scheduling algorithm can receive one ticket for each periodic task and one ticket for each non-periodic task. Alternatively, the task scheduling algorithm can receive a plurality of tickets for any of the periodic tasks and/or a plurality of tickets for any of the non-periodic tasks. For example, the task scheduling algorithm may receive one ticket for each task segment. In another alternative embodiment, the task scheduling algorithm may receive tickets corresponding to only a portion of the tasks. For example, the task scheduling may not receive a ticket for a task which is currently executing, for a periodic task which has not been released, etc. In one embodiment, instead of receiving the updated tickets, the task scheduling algorithm can be adapted to generate and/or update the tickets.

In an operation 305, the task scheduling algorithm can determine whether a periodic task is ready to execute. The task scheduling algorithm can make this determination by examining the parameters included on the updated tickets corresponding to periodic tasks. In an exemplary embodiment, a periodic task can be ready to execute if it has been released. For example, if a periodic task is released at zero ms, the task scheduling algorithm can determine that the periodic task should be scheduled to execute prior to any other task. If a plurality of periodic tasks are released at zero ms, the task scheduling algorithm can examine the periodic task deadlines on the tickets and schedule the periodic task with the earliest deadline to execute first. If any of the plurality of periodic tasks have the same deadline, the task scheduling algorithm can examine the periodic task priorities on the tickets and schedule the periodic task with the highest priority to execute first. If any of the plurality of periodic tasks have the same deadline and same priority, the task scheduling algorithm can schedule the periodic tasks based on alphabetical order, numeric order, randomly, or using any other criteria. In an alternative embodiment, the task scheduling algorithm can use any other criteria to determine whether a periodic task should be scheduled for execution. For example, periodic tasks may not be scheduled for execution as soon as they are released such that one or more non-periodic tasks are able to be scheduled. In an exemplary embodiment, periodic tasks can be scheduled to execute at any time such that the deadlines of the periodic tasks are met.

If the task scheduling algorithm determines that a periodic task is ready for execution, the task scheduling algorithm schedules the periodic task to execute in an operation 310. In an exemplary embodiment, the task scheduling algorithm can schedule a single periodic task at a time. Alternatively, the task scheduling algorithm can schedule a plurality of periodic tasks at once. For example, a periodic task A can be released at zero ms, have a deadline of twenty-five ms, and have a priority of two, and a periodic task B can be released at zero ms, have a deadline of twenty-five ms, and have a priority of one. The task scheduling algorithm can schedule periodic task A to execute first and schedule periodic task B to automatically execute upon completion of the execution of periodic task A. In an exemplary embodiment, the central processing unit or other computing unit can cause the periodic task to execute at the scheduled time as known to those skilled in the art.

In an exemplary embodiment, the scheduling of the periodic task can take place at any time during runtime. For example, the task scheduling algorithm can schedule the periodic task right at startup. The task scheduling algorithm can also schedule the periodic task subsequent to a yield invocation from an executing task (or task segment) which has completed execution. By waiting for the yield invocation, the task scheduling algorithm can schedule a subsequent task based on the actual execution time of the previous task, and not on a WCET of the previous task. In general, the actual execution time of a task may be significantly less than the global WCET or even the dynamic WCET of the task. As such, there may be sufficient time to schedule a non-periodic task (or task segment) prior to scheduling the next periodic task. Scheduling opportunities may be lost if scheduling is implemented prior to the yield invocation from a previously scheduled task. In an alternative embodiment, the task scheduling algorithm can schedule the periodic task while a previously scheduled task (or task segment) is executing.

Upon scheduling the periodic task, the task scheduling algorithm can again receive updated tickets in operation 300. In an exemplary embodiment, the updated tickets can be received at any time during or after the scheduling of the previously scheduled periodic task. For example, the updated tickets can be received while the previously scheduled periodic task is executing. Alternatively, the updated tickets can be received after the periodic task is scheduled but prior to execution of the periodic task. In another alternative embodiment, the updated tickets can be received after execution of the previously scheduled periodic task. In an exemplary embodiment, the task scheduling algorithm can use the updated tickets to schedule a subsequent task. For example, the task scheduling algorithm can use the updated tickets to determine whether a periodic task is ready to execute in operation 305. If a periodic task is ready to execute, the task scheduling algorithm can schedule the periodic task in operation 310. This cycle can be continually repeated throughout the runtime of the embedded system.

If during any cycle, a periodic task is not ready to execute, the task scheduling algorithm can determine whether a non-periodic task can be scheduled to execute in an operation 320. In an exemplary embodiment, the non-periodic task can be an entire non-periodic task or a task segment of a non-periodic task. The task segment can be a predefined task segment, or a task segment which is defined by the task scheduling algorithm during runtime. The task scheduling algorithm can determine whether to schedule a non-periodic task by comparing the dynamic WCETs on the tickets of non-periodic tasks to an available time period. The available time period can be the time before the next periodic task is released. Alternatively, the available time period can be the amount of time until a periodic task has to commence execution such that it completes execution prior to the periodic task's deadline. Alternatively, the available time period can be any other period of time during which a non-periodic task can execute without causing a deadline of a periodic task to be missed.

In an exemplary embodiment, the determination of whether a non-periodic task can be scheduled to execute can be made upon invocation of a yield command from a previously scheduled task. As described above, the actual execution time of the previously scheduled task may be significantly less than its global WCET or dynamic WCET. As such, a scheduling determination made prior to invocation of the yield command may not be optimal. For example, a task which is currently executing can have a WCET of 10 ms, a non-periodic task A can have a dynamic WCET of 5 ms and a non-periodic task B can have a dynamic WCET of eight ms. Based on the WCET of the currently executing task, an available time period can be five ms. As such, the task scheduling algorithm can confidently schedule non-periodic task A while the currently executing task is still executing. However, the currently executing task may complete execution and invoke a yield command after only six ms. Based on this early completion, the available time period may actually be nine ms, and the task scheduling algorithm can schedule non-periodic task B to execute. In this example, waiting to schedule until invocation of the yield command potentially eliminated three or more ms of idle time. In alternative embodiments, the determination regarding whether a non-periodic task can be scheduled can be made at any other time.

If a determination is made that a non-periodic task can be scheduled to execute, the task scheduling algorithm can schedule the non-periodic task to execute in an operation 325. The non-periodic task can be scheduled to execute immediately if the previously scheduled task has completed execution. Alternatively, the non-periodic task can be scheduled to execute subsequent to a currently executing periodic or non-periodic task. In another alternative embodiment, if the available time period is of sufficient length, a plurality of non-periodic tasks can be scheduled at the same time.

Upon scheduling the non-periodic task, the task scheduling algorithm can again receive updated tickets in operation 300. In an exemplary embodiment, the updated tickets can be received at any time during or after the scheduling of the previously scheduled non-periodic task. In an exemplary embodiment, the task scheduling algorithm can use the updated tickets to schedule a subsequent task. For example, the task scheduling algorithm can use the updated tickets to determine whether a periodic task is ready to execute in operation 305, and the cycle can continue throughout runtime.

If there is no periodic task ready to execute, and no non-periodic task which can be scheduled to execute, the task scheduling algorithm can schedule an idle time in an operation 335. In an exemplary embodiment, the idle time can be the length of time until a periodic task is ready to be executed. As an example, an embedded system can include two periodic tasks (F and G) and a single non-periodic task H. At a runtime of eighty ms, periodic task F can complete execution, and periodic task B may not be ready to execute until eighty-two ms. If non-periodic task H has a dynamic WCET which is greater than two ms, the task scheduling algorithm can schedule idle time for two ms. Alternatively, the task scheduling algorithm may schedule non-periodic task H to execute following periodic task F as long as periodic task G is still able to complete execution prior to its deadline.

### Experimental Results:

An experiment was conducted to determine the effect of incorporating the above-described compiler-aided ticket scheduling (CATS) into a task scheduling algorithm. The experiment was based on a conceptual model of an embedded system within a space shuttle (space shuttle system). A task set including three periodic tasks and two non-periodic tasks was designed for the space shuttle system. The tasks were designed to be executed on the space shuttle, which is controlled from the ground. The experiment was conducted using a computer with a high speed processor, a non-preemptive network interface card operating system, and a CATS enhanced non-preemptive earliest deadline first (EDF) task scheduling algorithm. Results obtained using the CATS enhanced EDF task scheduling algorithm were then compared to results obtained using a regular EDF task scheduling algorithm.

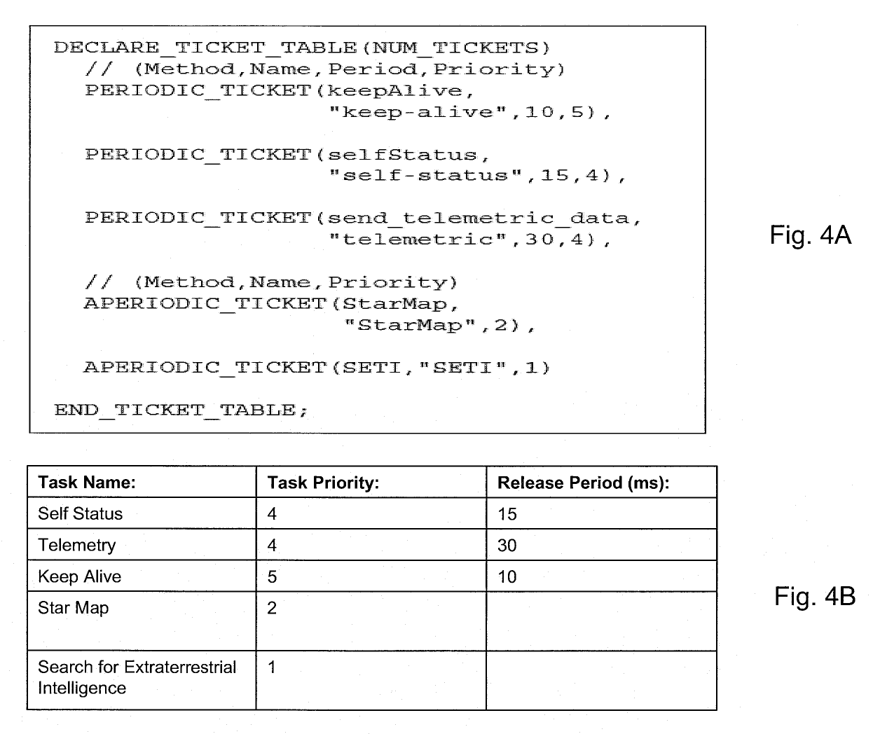

FIG. 4A is a task definition table illustrating parameters of the task set of the space shuttle system. The task definition table, which includes the three periodic tasks and the two non-periodic tasks, defines task names, task priorities, and release periods for periodic tasks. The first periodic task is a self status task in which the space shuttle system collects various data (fuel usage, engine heat, etc.) and sends it to the ground station. The second periodic task is a telemetry task in which the space shuttle system groups measurements such as interior air pressure, speed, and temperature, and sends them back to the ground station. The third periodic task is a keep alive task in which the space shuttle system receives a ‘keep alive’ signal from the ground station. If a keep alive signal is not received for a predetermined duration of time, the space shuttle system is programmed to self destruct.

The first non-periodic task is a star map task in which the space shuttle system takes a photograph of outer space, compresses the photograph, and sends the photograph to the ground station. The star map task was divided into two task segments. The first task segment is a star map shoot task segment in which the photograph is taken, and the second segment is a star map zip and send task segment in which the photograph is compressed and sent to the ground station. The second non-periodic task is a search for extraterrestrial intelligence (SETI) task in which the space shuttle system transmits signals and processes any responses to the transmitted signals in an attempt to make contact with extraterrestrial life forms. The SETI task was divided into four task segments. The task segments include a SETI hello task segment in which a signal is transmitted, a SETI listen task segment in which any responses to the signal are received, a SETI analyze task segment in which any received responses are analyzed, and a SETI report task segment in which extraterrestrial activity is reported to the ground station. FIG. 4B is a table summarizing the information included in the task definition table described with reference to FIG. 4A.

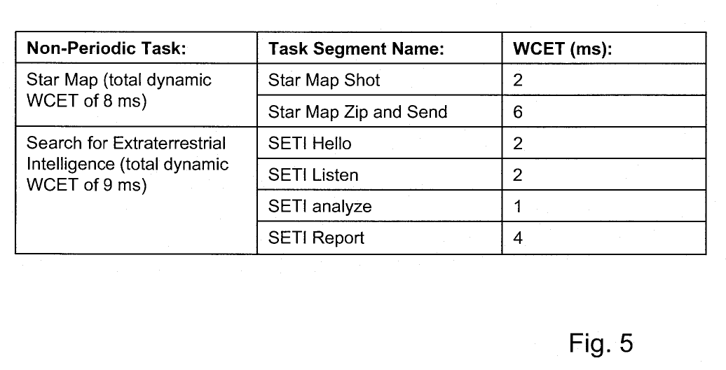

Once the tasks were defined, they were written into source code by programmers. A compiler was used to compile the source code and determine the worst case execution times and constraints for each task. Based on this information, a task schedule was simulated to identify the maximum available time period during runtime. The maximum available time period can be the largest possible time duration available for execution of a non-periodic task without breeching a deadline of a periodic task. If the maximum available time period is smaller than any WCET of a non-periodic task, the non-periodic may not ever have enough time to complete execution. The maximum possible idle period in the space shuttle system was found to be six ms. However, the WCET of the (non-periodic) star map task was calculated at eight ms and the WCET of the (non-periodic) SETI task was calculated at nine ms. Thus, as described above, the star map task was divided into two task segments and the SETI task was divided into four task segments. FIG. 5 is a table illustrating the task segments and their WCETs in accordance with an exemplary embodiment. The WCETs of the task segments range from one to six ms. As a result, each of the task segments is able to execute within the maximum available time period of six ms. In an exemplary embodiment, non-periodic tasks can be divided into segments even if all of the non-periodic tasks have a WCET which is less than the maximum available time period. In an alternative embodiment, the task scheduling algorithm can divide tasks into task segments during runtime based on dynamic WCETs and other runtime information.

A ticket was generated for each periodic task and each non-periodic task. The tickets were used by the EDF task scheduling algorithm to optimize the task scheduling process as described with reference to FIG. 3. With respect to task execution, the operating system of the space shuttle system created a dedicated queue for each task. The dedicated queue was used as an inter-task communication mechanism to control task execution. Any tasks in the queue remained in a sleep mode until a specific message from the task scheduling algorithm was received. When the specific message arrived, the task was awoken and prepared for execution at the scheduled time. During the experiment, the space shuttle system was executed two times. During the first execution, a regular earliest deadline first (EDF) task scheduling algorithm was used. During the second execution an EDF task scheduling algorithm enhanced by compiler-aided ticket scheduling (CATS) as described with reference to FIGS. 1-3 was used.

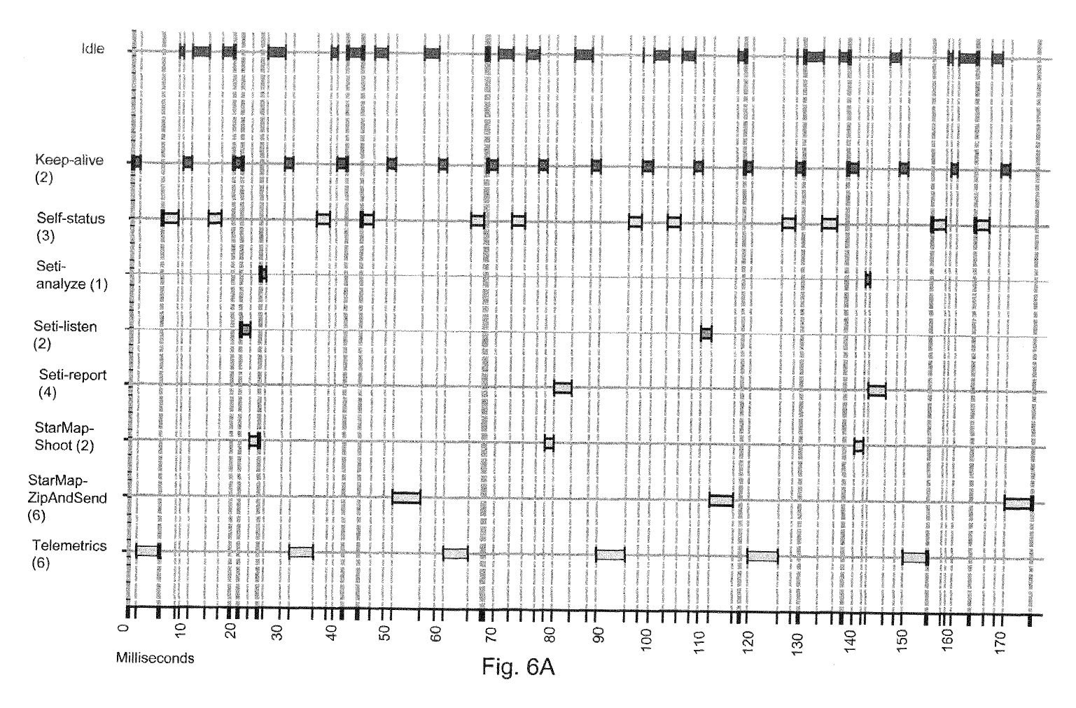

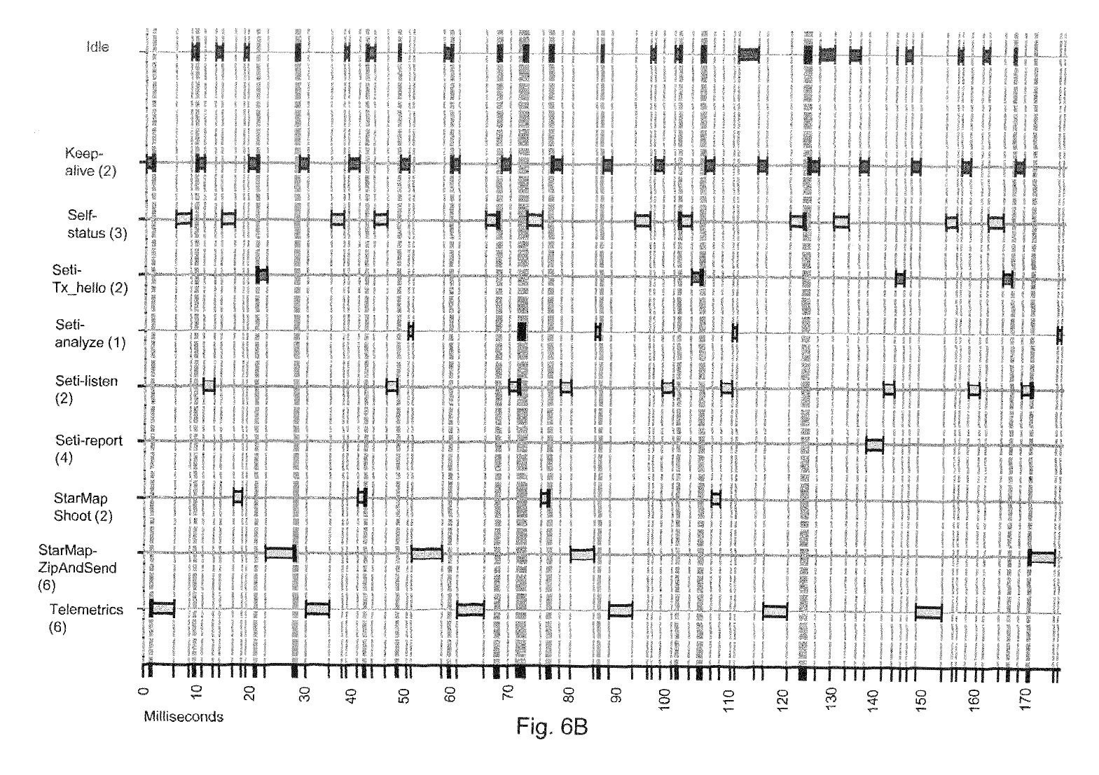

FIG. 6A is a graph illustrating the tasks scheduled by the regular EDF task scheduling algorithm, and FIG. 6B is a graph illustrating the tasks scheduled by the CATS enhanced EDF task scheduling algorithm. The x axes of the graphs illustrate the time in ms, and the y axes illustrate the tasks and task segments which were executed. The shaded rectangles in the graphs illustrate the actual execution time for each task and task segment. An analysis of the results illustrated with reference to FIGS. 6A and 6B indicates that the CPU was idle for 28.6% of the time when the regular EDF task scheduling algorithm was used, and for only 14.7% of the time when the CATS enhanced EDF task scheduling algorithm was used. Thus, use of the CATS enhanced EDF scheduling algorithm resulted in an increase of CPU utilization from 71.4% to 85.3%. The increase in CPU utilization translates to an increase of 20% in the throughput of the space shuttle system.

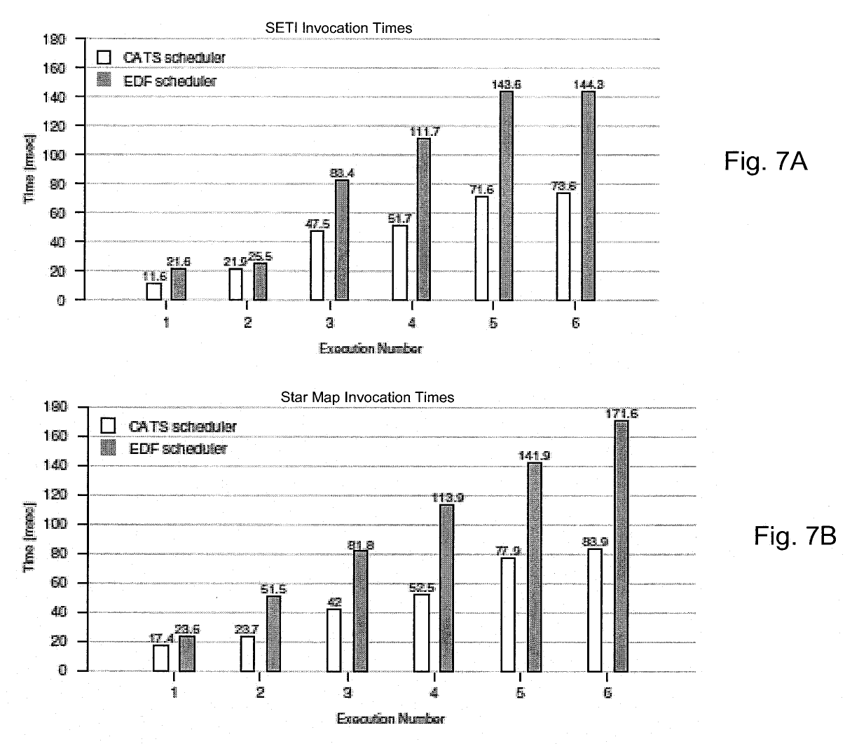

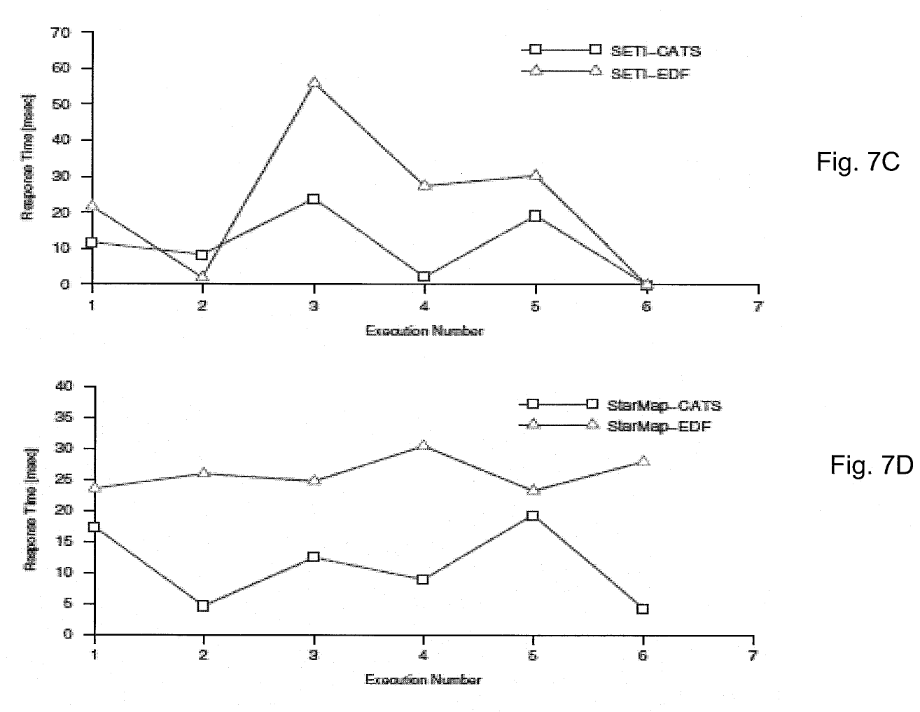

The analysis of the results also shows that the non-periodic tasks have significantly earlier invocation (or response) times during the space shuttle system execution which utilized the CATS enhanced EDF task scheduling algorithm. FIG. 7A is a graph illustrating a comparison of invocation times of the SETI task. As illustrated, a first task segment of the SETI task was invoked at 11.6 ms using the CATS enhanced EDF task scheduling algorithm, and at 21.6 ms using the regular EDF task scheduling algorithm. A second task segment of the SETI task was invoked at 21.9 ms using the CATS enhanced EDF task scheduling algorithm, and at 25.5 ms using the regular EDF task scheduling algorithm. A third task segment of the SETI task was invoked at 47.5 ms using the CATS enhanced EDF task scheduling algorithm, and at 83.4 ms using the regular EDF task scheduling algorithm, and so on. FIG. 7B is a graph illustrating a comparison of invocation times of the star map task.

FIG. 7C is a graph illustrating the time in between consecutive invocations of the SETI task using both the regular and the CATS enhanced EDF task scheduling algorithms. With the regular EDF task scheduling algorithm, the SETI task was first invoked at 21.6 ms, and the time between the first invocation and the second invocation was 3.9 ms. The time between the second invocation and the third invocation was 57.9 ms, the time between the third and the fourth invocation was 28.3 ms, the time between the fourth and fifth invocation was 31.9 ms, and the time between the fifth and sixth invocation was 0.7 ms. With the CATS enhanced task scheduling algorithm, the SETI task was first invoked at 11.6 ms, and the time between the first and second invocations was 10.3 ms. The time between the second and third invocations was 25.6 ms. The time between the third and fourth invocations was 4.2 ms. The time between the fourth and fifth invocations was 19.9 ms, and the time between the fifth and sixth invocations was 2 ms. The average response time between consecutive invocations of the SETI task using the regular EDF task scheduling algorithm was 22.86 ms, versus 10.83 ms when the CATS enhanced EDF task scheduling algorithm was used. The decrease in response time corresponds to a 53% decrease in the average waiting time. Thus, it can be seen that the response time was significantly improved by the CATS enhanced EDF task scheduling algorithm.

FIG. 7D is a graph illustrating the time in between consecutive invocations of the star map task using both the regular and the CATS enhanced EDF task scheduling algorithms. The average response time between consecutive invocations of the star map task using the regular EDF task scheduling algorithm was 26.03 ms, versus 11.23 ms when the CATS enhanced EDF task scheduling algorithm was used. This corresponds to a 57% decrease in the average waiting time with the CATS enhanced EDF task scheduling algorithm. The analysis further revealed that the average invocation time for periodic tasks was approximately the same using both task scheduling algorithms. Thus, the improvements with respect to the non-periodic tasks did not adversely affect execution of the periodic tasks.

One or more flow diagrams have been used herein to describe exemplary embodiments. The use of flow diagrams is not meant to be limiting with respect to the order of operations performed. Further, for the purposes of this disclosure and unless otherwise specified, “a” or “an” means “one or more.” Any patents, applications, references and publications cited herein are incorporated by reference in their entirety to the same extent as if they were individually incorporated by reference.

The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method of scheduling tasks for execution in a computer system, the method comprising:
determining a dynamic worst case execution time for a non-periodic task, wherein the dynamic worst case execution time is based on an actual execution path of the non-periodic task;
determining an available time period, wherein the available time period is an amount of time available for execution of the non-periodic task; and
scheduling the non-periodic task for execution if the dynamic worst case execution time is less than the available time period.

2. The method of claim 1, further comprising generating a ticket for the non-periodic task, wherein the ticket includes the dynamic worst case execution time.

3. The method of claim 2, wherein the ticket further includes a priority value for the non-periodic task.

4. The method of claim 2, wherein the ticket is generated by a compiler.

5. The method of claim 2, wherein the ticket is generated by a task scheduling algorithm.

6. The method of claim 2, further comprising providing the ticket to a task scheduling algorithm.

7. The method of claim 1, further comprising updating the ticket with an updated dynamic worst case execution time.

8. The method of claim 1, wherein the dynamic worst case execution time is determined at least in part by a compiler.

9. The method of claim 1, wherein the available time period comprises a duration of time from startup until a periodic task is released for execution.

10. The method of claim 1, wherein the available time period comprises a duration of time from completion of a task until a time at which a periodic task is released for execution.

11. The method of claim 1, wherein the available time period is a duration of time from completion of a task until a time by which the periodic task must commence execution such that a deadline of the periodic task is met.

12. The method of claim 1, further comprising determining a worst case execution time for a periodic task.

13. The method of claim 12, wherein the available time period is based at least in part on the worst case execution time for the periodic task.

14. The method of claim 12, wherein the worst case execution time for the periodic task is included in a ticket corresponding the periodic task.

15. The method of claim 14, wherein the ticket further includes a priority value of the periodic task.

16. The method of claim 1, further comprising dividing the non-periodic task into a plurality of task segments.

17. The method of claim 16, further comprising determining a task segment dynamic worst case execution time for a task segment in the plurality of task segments.

18. The method of claim 17, further comprising scheduling the task segment for execution if the task segment dynamic worst case execution time for the task segment is less than or equal to the available time period.

19. The method of claim 1, further comprising scheduling the non-periodic task for execution if the dynamic worst case execution time is equal to the available time period.

20. The method of claim 1, wherein the available time period is determined after a previously scheduled task has completed execution such that the available time period is based on an actual execution time of the previously scheduled task.

21. The method of claim 1, wherein the available time period is determined while a previously scheduled task is executing.

22. A computer-readable medium having computer-readable instructions stored thereon that, upon execution by a processor, cause the processor to schedule tasks for execution, the instructions configured to:
generate a first ticket for a non-periodic task, wherein the first ticket comprises a dynamic worst case execution time for the non-periodic task;
generate a second ticket for a periodic task, wherein the second ticket comprises a parameter corresponding to the periodic task;
determine an available time period based at least in part on the parameter; and
schedule the non-periodic task for execution if the dynamic worst case execution time is less than or equal to the available time period.

23. The computer-readable medium of claim 22, wherein the first ticket is generated by a compiler.

24. The computer-readable medium of claim 22, wherein the instructions are further configured to update the first ticket to reflect an updated dynamic worst case execution time.

25. The computer-readable medium of claim 24, wherein the first ticket is updated while a previously scheduled task is executing.

26. The computer-readable medium of claim 24, wherein the ticket is updated subsequent to scheduling of a previously scheduled task.

27. The computer-readable medium of claim 22, wherein the instructions are further configured to update the second ticket to reflect an updated parameter.

28. The computer-readable medium of claim 22, wherein the parameter comprises a release interval.

29. The computer-readable medium of claim 22, wherein the parameter comprises a deadline, wherein the deadline comprises a time by which the periodic task must complete execution.

30. The computer-readable medium of claim 22, wherein the parameter comprises a priority value.

31. The computer-readable medium of claim 22, wherein the parameter comprises a time of next release value.

32. The computer-readable medium of claim 22, wherein the parameter comprises a release time of the periodic task, wherein the release time comprises a first time at which the periodic task is released for execution.

33. The computer-readable medium of claim 22, wherein the parameter comprises a time by which the periodic task must commence execution such that a deadline of the periodic task is met.

34. The computer-readable medium of claim 22, wherein the parameter comprises a worst case execution time for the periodic task.

35. The computer-readable medium of claim 34, wherein the worst case execution time for the periodic task comprises a global worst case execution time.

36. The computer-readable medium of claim 34, wherein the worst case execution time for the periodic task comprises a dynamic worst case execution time.

37. The computer-readable medium of claim 22, wherein the instructions are further configured to divide the non-periodic task into a plurality of task segments.

38. The computer-readable medium of claim 37, wherein the non-periodic task is divided during runtime, and wherein the division is based at least in part on the available time period.

39. The computer-readable medium of claim 22, wherein the first ticket further comprises a non-periodic priority value.

40. A method of implementing a computing system comprising:
defining a task set, wherein the task set comprises a periodic task and a non-periodic task;
determining one or more worst case execution times for the periodic task;
determining one or more worst case execution times for the non-periodic task;
generating a periodic task schedule based at least in part on the one or more worst case execution times for the periodic task; and
providing at least one of the one or more worst case execution times for the non-periodic task to a task scheduling algorithm such that the task scheduling algorithm can determine whether the non-periodic task can be scheduled for execution during an available time period such that the periodic task schedule is not disrupted.

41. The method of claim 40, further comprising generating source code corresponding to the periodic task and the non-periodic task.

42. The method of claim 41, further comprising compiling the source code corresponding to the periodic task and the non-periodic task.

43. The method of claim 40, further comprising defining a priority value for the periodic task.

44. The method of claim 40, further comprising defining a release interval for the periodic task.

45. The method of claim 44, wherein the periodic task schedule is based at least in part on the release interval of the periodic task.

46. The method of claim 40, wherein each of the one or more worst case execution times for the non-periodic task is a dynamic worst case execution time corresponding to a distinct execution path of the non-periodic task.

47. The method of claim 40, further comprising creating a control flow graph for the non-periodic task, wherein the control flow graph identifies one or more distinct execution paths of the non-periodic task.

48. The method of claim 47, wherein the control flow graph is used in conjunction with a simulator to determine the one or more worst case execution times for the non-periodic task.

49. A computing device comprising:
a task scheduling application, wherein the task scheduling application comprises computer code configured to
receive a dynamic worst case execution time of a non-periodic task, wherein the dynamic worst case execution time is based on an actual execution path of the non-periodic task;
determine an available time period, wherein the available time period is an amount of time available for execution of the non-periodic task; and
schedule the non-periodic task for execution if the dynamic worst case execution time is less than the available time period;
a memory configured to store the task scheduling application; and
a processor coupled to the memory, wherein the processor is configured to execute the task scheduling application.
